(19) United States
(12) Patent Application Publication
(10) Pub. No.: US 2005/0288807 A1
(43) Pub. Date: Dec. 29, 2005

(54) Semi-automated computer-implemented method and system for designing manifold assemblies

(75) Inventors: Patrick A. Tooman, Clarkston, MI (US); Bruce J. Casey, White Lake, MI (US); Robert Durand, Waterford, MI (US); Edward Otlewski, Orion, MI (US)

Correspondence Address: BROOKS KUSHMAN P.C., 1000 TOWN CENTER, TWENTY-SECOND FLOOR, SOUTHFIELD, MI, 48075, US

(73) Assignee: Plastic engineering & Technical Services, Inc., Auburn Hills, MI (US)

(21) Appl. No.: 10/875,457

(22) Filed: Jun. 24, 2004

(51) Int. Cl. G06F 19/00

(52) U.S. Cl. 700/97; 700/98; 425/145; 264/328.8; 700/200

(57) ABSTRACT

A semi-automated computer-implemented method for designing manifold assemblies. The method can include receiving a number of design parameters for the design of a manifold assembly and applying the number of design parameters to a heater and zoning logic to generate a manifold assembly design.

### BACKGROUND OF THE INVENTION

1. Field of the Invention

One aspect of the present invention relates to a semi-automated computer-assisted method and system for designing manifold assemblies, and more specifically, hot runner manifold assemblies.

2. Background Art

Hot runner manifold assemblies are used to deliver molten plastic into injection molds. A hot runner manifold can be comprised of a steel casing that distributes molten plastic, wood or steel, or mixtures thereof, from the outlet of a molding machine to the mold. Examples of steel casings include, but are not limited to, cast round, square, or rectangular; and machined round, square, or rectangular. Plastic enters the manifold through one or more sprue bushings and exits to the mold through one or more drops. One or more valve gates may be used to control the flow through the one or more drops. The manifold is typically retained by compression between the molding machine and the mold steel. The manifold seals to the one or more sprues and one or more drops, which is commonly referred to as the preload step. Pressure pads and preload plates are mounted on the manifold opposite from the sprue and drops.

Conventionally, hot runner manifold assemblies are designed using computer aided design (“CAD”) applications. Typically, the design process begins with a customer order. The customer provides drawings of the injection mold to the manifold designer. Optionally, mold flow analysis can be conducted on the mold. Based on the mold drawings, a manifold designer designs a pattern drawing of the manifold in a CAD system, which usually takes about a week.

Once the customer approves the pattern drawing, the design process proceeds down two paths—pattern building and preliminary drawing completion. Pattern building includes pattern checking, pattern construction, pattern verification, foundry work for producing the cast manifold, and cast making. Preliminary drawing completion includes detailing for the preliminary drawing package, drawing checking, and drawing completion. The pattern building and preliminary drawing completion processes are executed in parallel and usually take about three to four weeks to complete. Once the customer signs off on the completed drawing, which usually takes about a week, the rest of the design process is completed, which includes final detailing, final package drawing, release to manufacturing, manufacture manifold from machined round, rectangular or square casting, and shipping. The rest of the process typically takes about four days. Overall, the conventional design process takes about six to seven weeks to complete.

The conventional process outlined above does not utilize automation. Although some legacy data is used for layout, the process utilizes manual two-dimensional drawing with CAD. Two-dimensional views for blueprints are prepared by converting a three-dimensional solid, via CAD software. This conversion consumes a substantial amount of man-hours. Further, the conventional process leads to bottlenecking at the detailing for preliminary design and checking steps.

In light of the foregoing, what is needed is a semi-automated computer-implemented method and system for designing manifold assemblies, which shortens the conventional design cycle. What is also needed is a computer-implemented method and system for automatically generating two-dimensional layouts based on three-dimensional solids.

### SUMMARY OF THE INVENTION

One aspect of the present invention relates to a semi-automated computer-implemented method and system for designing manifold assemblies for shortening the conventional design cycle. The present invention also includes a computer-implemented method and system for automatically generating two-dimensional layouts based on three-dimensional solids. One advantage of the present invention is design cost savings. Another advantage of the present invention is increased design capacity that may lead to business growth. Other advantages over the conventional system can include, but are not limited to, decreased preliminary detailing, decreased final detailing, increased sales, elimination of manual creation of bill of materials, increased quality, and lower product development costs.

According to a first embodiment of the present invention, a semi-automated computer-implemented method for designing manifold assemblies is disclosed. The method includes receiving a number of design parameters for the design of a manifold assembly and applying the number of design parameters to a heater and zoning logic to generate a manifold assembly design. The method can further include generating two-dimensional data for the manifold assembly based on the number of design parameters and the heater and zoning logic. The method can further include automatically generating a blueprint based on the two-dimensional data for the manifold assembly. In certain embodiments, the manifold assembly design includes a three-dimensional rendering of the manifold assembly. The method can further include automatically generating a bill of materials based on the two-dimensional data for the manifold assembly. The number of design parameters can include manifold size, sprue coordinates, and drop coordinates. The heater and zoning logic can include minimizing overall heater gap, minimize number of zones, and minimize number of heaters. The manifold assembly design can include a manifold, one or more drops, one or more heaters, one or more thermocouples, and one or more plugs.

According to a second embodiment of the present invention, a semi-automated computer-implemented system for designing manifold assemblies is disclosed. The system can include one or more computers. The one or more computers can be configured to receive a number of design parameters for the design of a manifold assembly and apply the number of design parameters to a heater and zoning logic to generate a manifold assembly design. The one or more computers can be further configured to generate two-dimensional data for the manifold assembly based on the number of design parameters and the heater and zoning logic. The one or more computers can be further configured to automatically generate a blueprint based on the two-dimensional data for the manifold assembly. The manifold assembly design can include a three-dimensional rendering of the manifold assembly. The one or more computers can be further configured to automatically generate a bill of materials based on the two-dimensional data for the manifold assembly. The number of design parameters can include manifold size, sprue coordinates, and drops. The heater and zoning logic can include minimizing overall, heater gap, minimize number of zones, and minimize number of heaters. The manifold assembly design can include a manifold, one or more drops, one or more heaters, one or more thermocouples, and one or more plugs.

According to a third embodiment of the present invention, a semi-automated computer-implemented apparatus for designing manifold assemblies is disclosed. The apparatus includes means for receiving a number of design parameters for the design of a manifold assembly and means for applying the number of design parameters to a heater and zoning logic to generate a manifold assembly design. The apparatus can further include means for generating two-dimensional data for the manifold assembly based on the number of design parameters and the heater and zoning logic. The apparatus can further include means for automatically generating a blueprint based on the two-dimensional data for the manifold assembly and/or means for automatically generating a bill of materials based on the two-dimensional data for the manifold assembly.

These and other objects of the present invention will become more apparent from a reading of the specification in conjunction with the drawings.

### BRIEF DESCRIPTION OF THE DRAWINGS

FIG. 1 depicts a computer system according to one embodiment of the present invention for CAD design of manifold elements;

FIG. 2 is a flowchart of a method according to one embodiment of the present invention that can be implemented using a computer system;

FIG. 3 is a GUI for inputting design parameters according to one embodiment of the present invention;

FIG. 4 is a GUI for displaying and modifying a manifold layout according to one embodiment of the present invention;

FIG. 5 is a GUI for displaying and modifying manifold heaters according to one embodiment of the present invention;

FIG. 6 is a GUI for displaying and modifying drop heaters according to one embodiment of the present invention;

FIG. 7 is a GUI for displaying a three-dimensional rendering of a manifold assembly according to one embodiment of the present invention;

FIG. 8 is a GUI for displaying and modifying a three-dimensional rendering of a manifold assembly according to one embodiment of the present invention;

FIG. 9 is a GUI for displaying and modifying a three-dimensional rendering of a manifold assembly according to one embodiment of the present invention;

FIG. 10 is a GUI for displaying and modifying a three-dimensional rendering of an end plug cut of a manifold assembly according to one embodiment of the present invention;

FIG. 11 is a three-dimensional rendering of a completed manifold assembly according to one embodiment of the present invention;

FIG. 12 is a two-dimensional drawing of a round, full size, standard drop which includes design parameter labels according to one embodiment of the present invention;

FIG. 13 is a two-dimensional drawing of a round, full size, split sprue drop which includes design parameter labels according to one embodiment of the present invention;

FIG. 14 is a two-dimensional drawing of a round, full size, low vestige drop which includes design parameter labels according to one embodiment of the present invention; and

FIG. 15 is a two-dimensional drawing of a round, down size, blind drop which includes design parameter labels according to one embodiment of the present invention.

### DETAILED DESCRIPTION OF EMBODIMENTS OF THE PRESENT INVENTION

The methods and systems of the present invention operate in the environment of manifold assembly design. Elements of a manifold assembly, include, but are not limited to, manifolds, heaters, thermocouples, pressure pads/preload plates, plugs, location rings, and drops. Manifolds are usually sand castings with raised bosses on both sides for drops, sprue, and pressure pads. Manifold types, include, but are not limited to, round manifolds (either two inch or three inch) and square manifolds. The pattern for the manifold can be a group of straight-line segments joining the sprue to each drop, or joining the sprue to an intermediate branch point that is joined to one or more drops. Straight segments are gun drilled to allow flow through the manifold. In certain embodiments, there can between about 1 to 120 drops per manifold.

Heaters are flat metal pads bent into a substantially circular form (for round castings, round stainless steel P-20 or H-13, or any other mold steel) to fit around the manifold and drops. The heaters contain electrical resistance elements and are wired together in zones. H-shaped units are used around bosses and straight units are used basically everywhere else on the manifold. Straight units may be used near bosses where no available H unit can fit. Full circle heaters are used around drops. Heaters are separated by standard gaps. The objective for heater use is to cover as much of the manifold and drops as possible for good thermal control. For square or rectangular shaped manifolds, heaters are usually tubular round or square in shape.

Thermocouples are placed in standard locations among the heaters to provide temperature feedback to the controller. For round and rectangular shaped castings, pressure pads and preload plates are used on top of bosses opposite sprue and drops. The pressure pads and preload plates are held in place by screws. Plugs seal ends of gun drilled passages and may include the plug itself, a set screw, and a bracket. Locating rings are circular plates that fit around sprue and drops for location. Drops can be of various diameters, various lengths, various bores, and various tip configuration and can include, but are not limited to, locating rings and retention screws and keys.

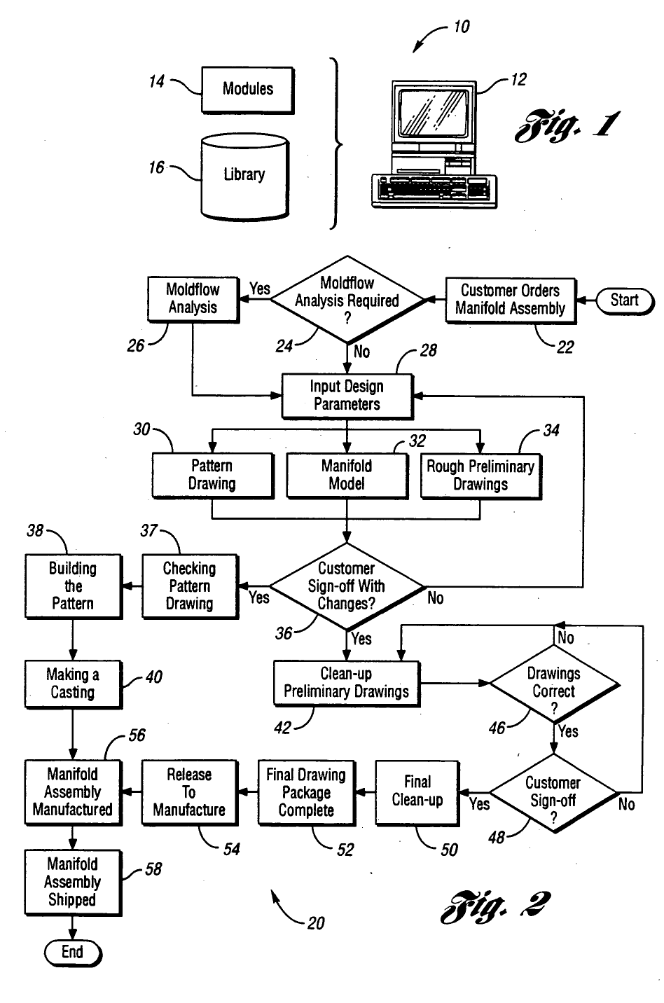

Having described in detail the elements of a manifold assembly, FIG. 1 depicts a computer system according to one embodiment of the present invention for CAD design of manifold elements, as well as other computer implemented functionality. System 10 of FIG. 1 includes computer 12. Computer 12 includes, but is not limited to, modules 14 and library 16. Modules 14 can include, but is not limited to, Solid Works software and a design module. Solid Works software can be used to design the elements of the manifold assembly. The designed elements can be stored to and retrieved from library 16. The optimization module can be used to implement the semi-automated computer-implemented systems of the present invention, and is disclosed in greater detail below. Computer 12 can be a personal computer, desktop or notebook. Computer 12 can be stand-alone or part of a computer network, depending on the implementation.

FIG. 2 is a flowchart of a method according to one embodiment of the present invention that can be implemented using computer system 10. It should be understood that elements of flowchart 20 can be modified, rearranged, and/or omitted according to different implementations of the present invention. According to block 22, a customer orders a manifold assembly. The customer usually provides mold drawings and sometimes moldflow analysis. If moldflow analysis is not completed by the customer and is required, as depicted in decision block 24, then moldflow analysis is conducted at block 26. In block 28, a user inputs design parameters into design module 14, which is described in greater detail below. The design module generates the pattern drawing (block 30), manifold model (block 32), and rough preliminary drawings (block 34). According to decision block 36, the customer has a decision as to whether to sign-off on the pattern drawing. The customer may sign-off with suggested changes. If the customer does not sign-off on the pattern drawing, then block 28 is repeated. If the customer does sign-off, then the design process proceeds down two paths. The first path includes checking the building pattern (block 37), building the pattern (block 38) and making a casting based on the pattern (block 40). While the steps described in blocks 37, 38 and 40 are being completed, another series of other steps are being completed in parallel. For example, block 42 describes clean-up of preliminary details. According to decision block 46, the user decides whether the drawing is complete and correct. If the drawing is not complete or not correct, then the step depicted in block 42 is repeated. If the drawing is complete and correct, then the drawings are presented for customer sign-off at decision block 48. If the customer does not sign-off, then the step depicted in block 42 is repeated. If the customer does sign-off, the process continues to final clean-up, as depicted by block 50. Further, the final drawing package is completed, as depicted in block 52 and release to manufacturing occurs in block 54. As depicted in block 56, the manifold assembly is manufactured from the casting provided from block 40. As depicted in block 58, the manufactured manifold assembly is shipped to the customer. This step typically ends the design process.

With respect to block 28, the user can input one or more design parameters into the design module 14. Design module 14 provides rapid design and manufacture of molding assemblies. The user can enter the following non-limiting parameters: manifold size (two inch round or three inch round), coordinates of sprue, drops and reference point (if different from sprue), intermediate points (if any), interconnection pattern, bore sizes, special heaters and lengths and tip style(s) for drops. According to logic described in detail below, the design module selects the following non-limiting design features based on the user input and contents of library 16: pattern model and drawing with tolerances, bosses/spacers (for preload pads, drops, and sprue), heaters (H-shaped around bosses, straight as fillers between Hs, straight as alternative to H where space restricted, thermocouples, tapped holes (pressure pads and plugs), drops (size, length, tip, and attachment to manifold), pressure pads and screws, other details, and desired outputs (standard drawing format, bill of materials, and isometric view).

According to one embodiment of the present invention, heater and zoning logic is used to aid the design of manifold assemblies. In general terms, the heater and zoning logic accounts for the placement of intersection heaters, body heaters, and drop heaters and the definition of zones, including the placement of thermocouples in each zone. In doing so, the following optimization rules are followed: (1) minimize overall heater gap; (2) minimize number of zones; and (3) minimize number of heaters. More specifically, the following optimization rules are followed: (1) only one drop may be defined in any heater zone; (2) two intersections may be combined into a single zone if the number of intersections excess number of available zones; (3) segment heaters are added in a circular fashion around an intersection if required; and (4) segment heaters are added to intersection zones, if required, in an even pattern to all intersections until a zone solution is found. The objective of these optimization rules is to (1) minimize overall gap between manifold heaters; (2) ensure maximum number of zones is not exceeded; (3) ensure maximum zone power is not exceeded; and (4) ensure that maximum/minimum clearance is not violated.

In certain embodiments, the heater and zoning logic is implemented in the following process by the design module. First, the total number of zones is estimated as the sum of the drop zones and intersections. If this sum is greater than the maximum number of allowable zone, then intersections are combined where possible. The process ends if the value of drop zones plus number of intersections minus intersection combinations exceeds maximum number of zones. In certain embodiments, the ability to fit an intersection heater is not analyzed during the process. Second, drops, including sprue, heater zones are reserved according to drop length. Third, intersection heaters are placed in the following order: (1) drops; (2) sprue; and (3) other intersections. Intersection H-heater(s) are replaced with smaller H-heater(s) if required to fit a segment heater. Fourth, segment heaters are placed. Fifth, an optimization routine searches available heater patterns until a solution is found which best meets optimization objectives. If the maximum number of optimization iterations is exceeded, the routine ends with no valid solution. Sixth, drop heaters and zones are defined.

The process also includes accounting for manifold intersections. Drop intersections can be two legs and linear. H-heaters can be placed on all intersections if space allows using largest H-heater available. If a standard H-heater will not fit, fitting an offset H-heater is attempted. If a intersection leg is a plug, then no minimum gap is required when placing a H-heater. If intersections are too close together to allow standard H-heaters, intersection H-heaters can be replaced with smaller H-heaters on all intersections. Non-drop intersections can be two legs and angled or three legs and two linear. In the first case, a split-heater can be placed on an outside angle of each leg. In the latter case, a split heater can be placed on the outside of an intersection with two linear legs. Sprue intersections can have two legs that are linear. The largest H-heater fitting the available space can be placed on an intersection. For manifold leg segments, all possible heater patterns are determined that fit defined segments which meet minimum and maximum clearance requirements. Heater patterns are first sorted by minimum clearance then by minimum number of heaters, that is, all possible permutations of heaters, which equal each possible coverage length, are determined. The logic optimizes the heater pattern placement to meet optimization objective.

The process also includes steps for placing thermocouples on the manifold. The tolerance between two thermocouples is about 2.5 inches at minimum. If two thermocouples are closer, then the process moves one relative to the other so that there is a minimum distance of about 2.5 inches. In certain embodiments, every zone needs a thermocouple. Zones on manifold legs with only one H-band heater need the thermocouple under the H-band. The location can be about 0.25 inches from the end of the H-band heater towards the drop. Zones on manifold leg with H-band and multiple solid heaters in the same zone can have the thermocouple located between the H-band and solid heater, regardless of the number of extra heaters in the zone. For main leg zones with two solid heater bands, the thermocouple can be between two heaters. For main leg zones with three solid heater bands, the thermocouple can be under the middle heater. For main leg zones with four heater bands, the thermocouple can be in the four heaters. This logic is true, as the number of heaters per zone increase. For heaters in a cross-section of main leg and drop leg, the thermocouple can be under the longest heater about 0.50 inches away from the edge of the heater. For heaters in a cross-section of main leg and drop leg, if there is another heater the same size in the same zone, then the thermocouple can be between the two larger heaters. To install a manifold thermocouple, drill a hole with a #27 bit, then drill and tap a one-fourth-20 thread perpendicular to the thermocouple opening.

The process also includes steps for thermocouple and heater placement. For tip heaters, an about 1.5 inch by about 2.0 inch heater is put on the following full size tip styles: standard sprue tips, all valve gate tip, and all guardian tips. The tip zone, thermocouple location can be about 0.25 inches away from shoulder. For down size drops, an about 1.0 inches by about 1.5 inches tip heater is used. For full size low vestige style, an about 1.0 inches by about 1.5 inches is placed on the threaded insert. For body heaters, there is up to three heaters per zone. Each heater has the same length. The body heater is placed directly under the drop head, in the undercut section. The rest of the heaters are placed with the gap tolerance. In certain embodiments, the gap tolerance between heaters is about 0.25 inches to about 0.75 inches. If one body heater is used for the body zone, then the thermocouple can be placed in the center of the heater. If two body heaters are used for the body zone, then the thermocouple can be placed between the two heaters. If three body heaters are used for the body zone, then the thermocouple can be placed in the middle of the center heater. If four body heaters are used, then the heaters are split equally. Two heaters for body zone one and the other two. heaters for body zone two. In certain embodiments, there are an equal number of heaters and equal lengths for each body zone. In certain embodiments, there is a limit of three zones per drop, that is, body zone one, body zone two, and tip zone. In other situations, there are two zones per drop, that is, body zone and tip zone. A drop thermocouple can be installed by drilling a hole with a #27 bit, then drilling and tapping a 8-32 thread in the middle and perpendicular to the #27 hole.

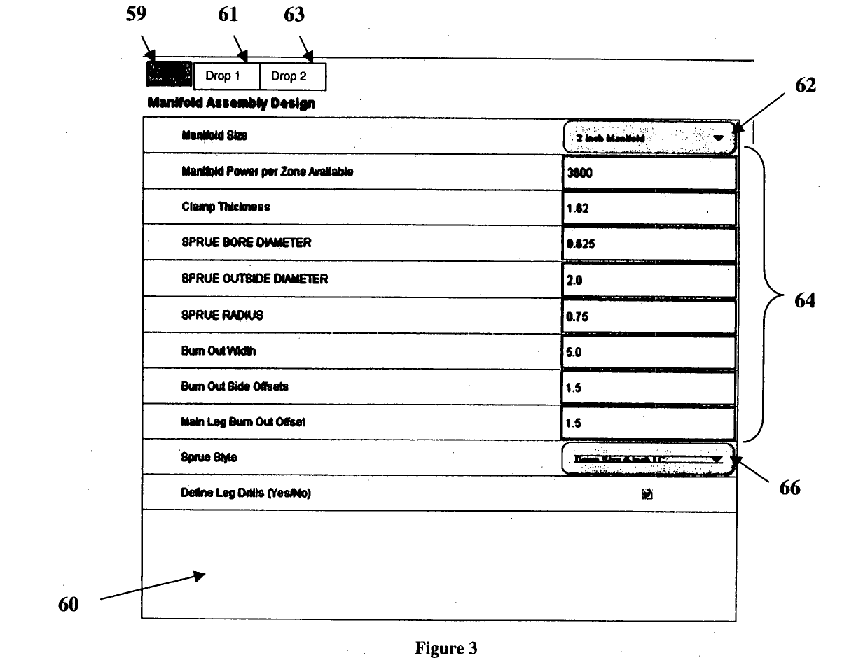

Having described the user inputs and one system logic of the design module, following is a description of a user interface for providing a semi-automated system according to one embodiment of the present invention. In certain embodiments, the user interface is a web-enabled collection of graphic user interfaces (GUIs). FIG. 3 is a GUI for inputting design parameters according to one embodiment of the present invention. FIG. 3 includes configuration tab 59, “Drop 1” tab 61 and “Drop 2” tab 63. Drop tabs 61 and 63 can be clicked to display a number of data input fields for defining drop lengths, cap diameters, and other parameters relating to drops.

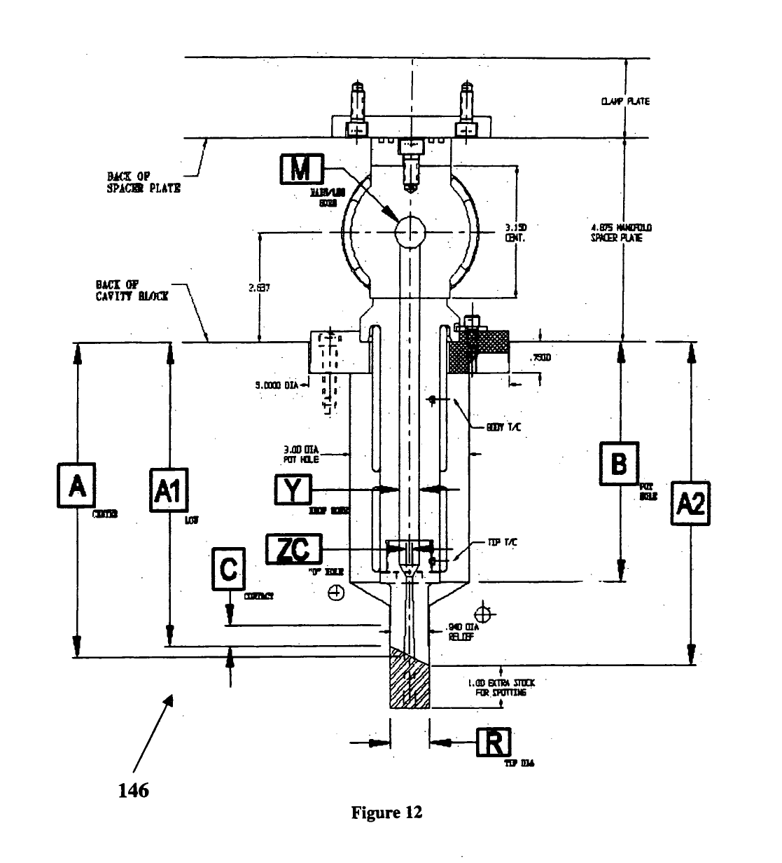

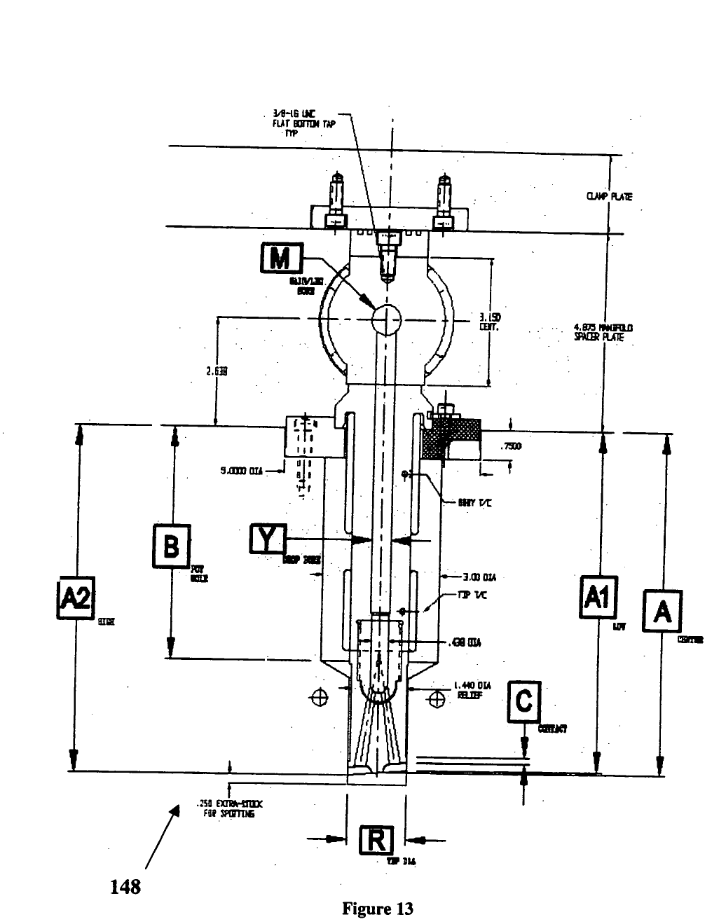

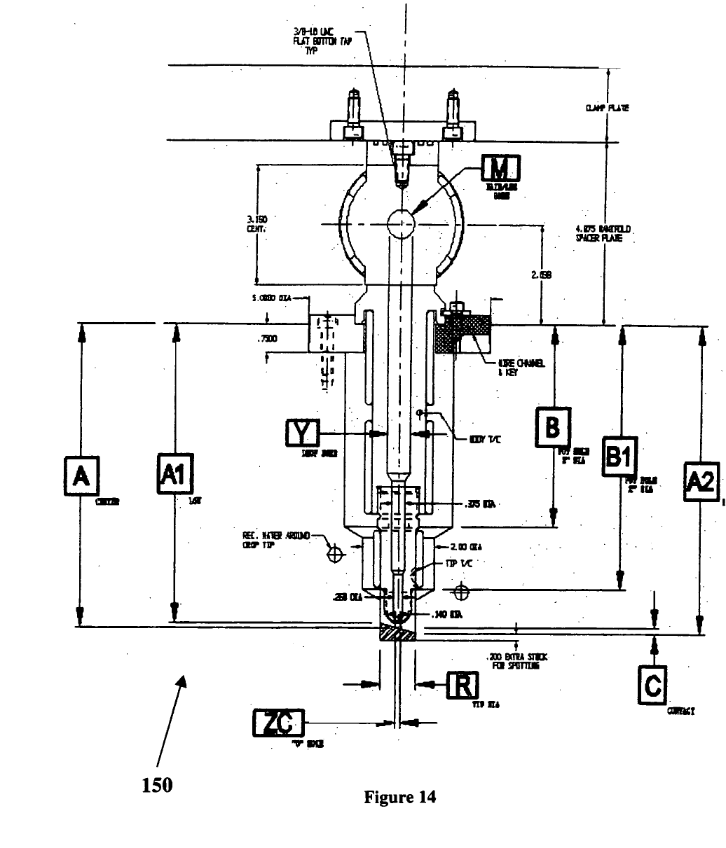

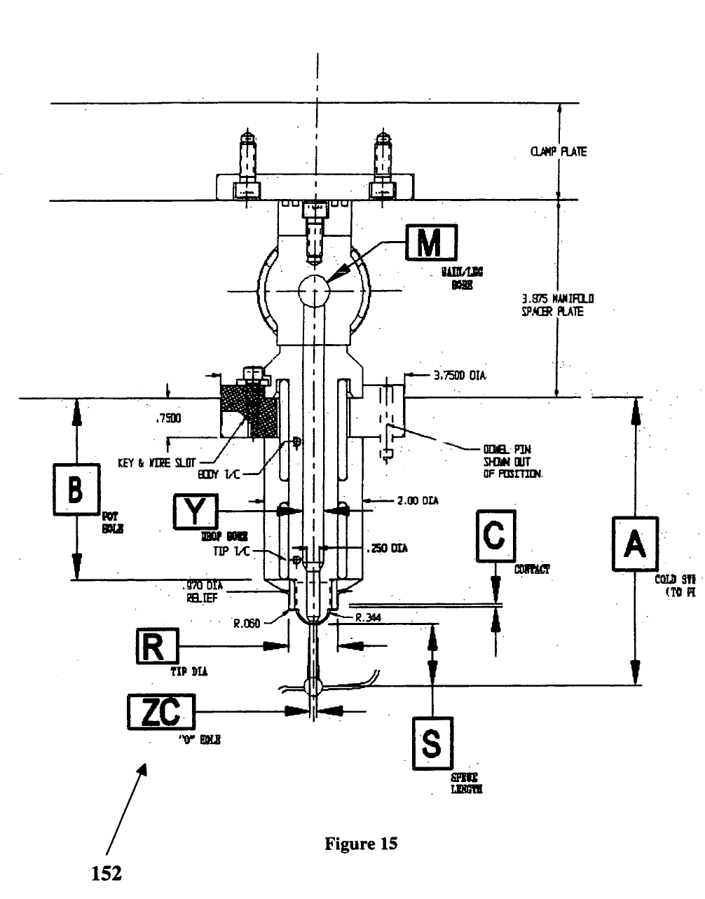

FIGS. 12-15 represent two-dimensional drawings of drops which include design parameter labels according to embodiments of the present invention. These drawings and other drop drawings can be stored in and retrieved from library 16. Each design parameter label can be assigned a data input field that is displayed by clicking on a drop tab, for example drop tabs 61 and 63. FIG. 12 is a two-dimensional drawing 146 of a round, full size, standard drop. Drawing 146 includes design parameter labels A (center), A1 (low), A2 (high), B (pot hole), C (contact), M (main/leg bore), R (tip diameter), Y (drop bore), and ZC (“O” hole). FIG. 13 represents a two-dimensional drawing of a round, full size, split sprue drop. Drawing 146 includes design parameter labels A (center), A1 (low), A2 (high), B (pot hole), C (contact), M (main/leg bore), R (tip diameter), and Y (drop bore). FIG. 14 represents a two-dimensional drawing 150 of a round, full size, low vestige drop. Drawing 150 includes design parameter labels A (center), A1 (low), A2, B (pot hole diameter), B1 (pot hole diameter), C (contact), M (main/leg bore), R (tip diameter), Y (drop bore), and ZC (“O” hole). FIG. 15 represents a two-dimensional drawing 152 of a round, down size, blind drop, which includes design parameter labels A (cold sprue), B (pot hole), C (contact), M (main/leg bore), R (tip diameter), S (sprue length), Y (drop bore), and ZC (“O” hole).

Referring back to FIG. 3, config. tab 59 of GUI 60 includes drop down box 62 for selecting the manifold type, a number of data input fields 64 for inputting design parameters, drop down box 66 for inputting sprue style, and check box 68 for defining leg drills (yes/no). According to GUI 60, the manifold selected is a two inch manifold, although other manifold types can be selected, for example, the three inch manifold.

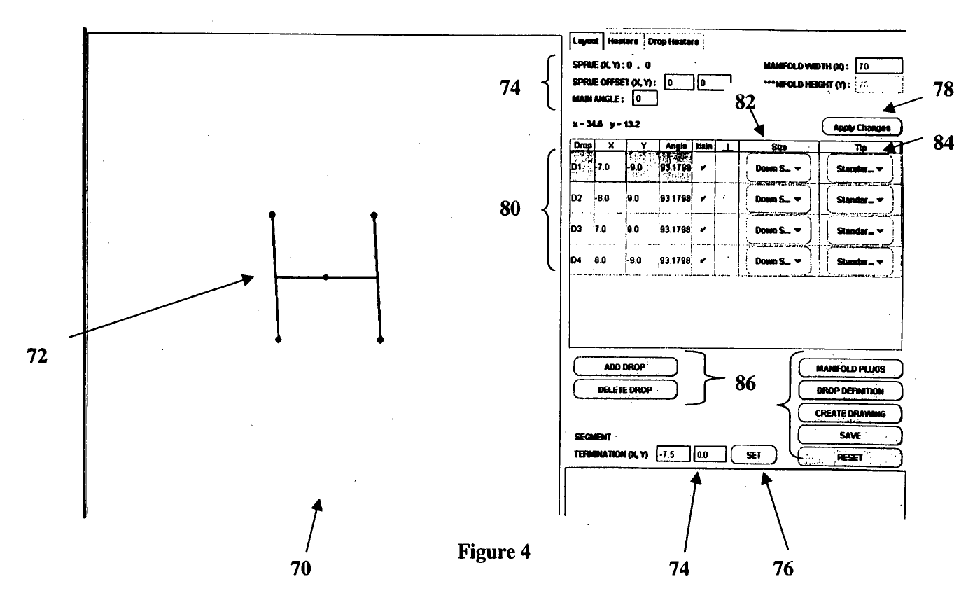

FIG. 4 is a GUI for displaying and modifying a manifold layout according to one embodiment of the present invention. GUI 70 includes graphic representation 72 of a manifold with drops according to the input of GUI 60. The manifold is represented by a number of line segments and the points represent the drops. GUI 70 also includes a layout tab for displaying and modifying layout information. GUI 70 includes the sprue coordinate. GUI 70 includes data input boxes 74 for entering a sprue offset, main angle, manifold width (X), manifold width (Y), and segment termination (X,Y). The user can set a modified segment termination by clicking on set button 76. For the other data input boxes, the user can apply modifications to the values by clicking on apply changes button 78. GUI 70 includes drop table 80. Each row(s) of drop table 80 contains information about each drop. In the case of drop table 80, there are four rows for four drops—D1, D2, D3, and D4. The information for each drop, includes, but is not limited to, X coordinate, Y coordinate, main indication, intersection indicator, size, and tip. The user clicks on down size button 82 or standard tip button 84 to view a table containing drop size information or tip size information, respectively. GUI 70 includes buttons 86 for add drop, delete drop, manifold plugs, drop definition, create drawing, save, and reset.

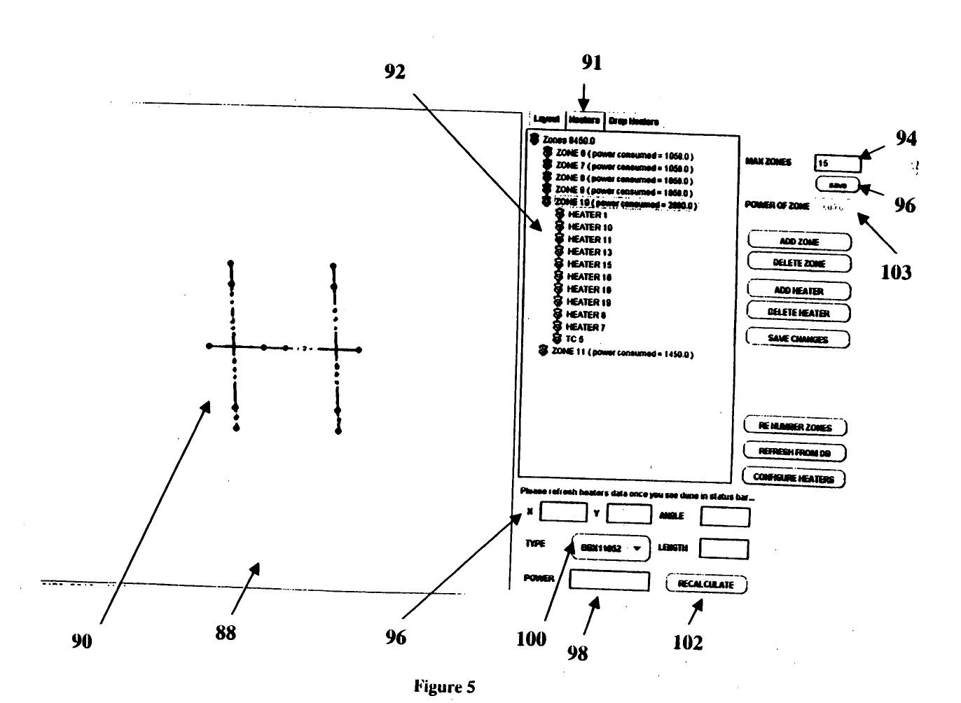

FIG. 5 is a GUI for displaying and modifying manifold heaters according to one embodiment of the present invention. GUI 88 includes graphic representation 90 of a manifold with drops and heaters. The heaters are represented by the dotted lines. GUI 88 also includes a heater tab for displaying and modifying heater information. GUI 88 includes selectable pull down list 92 containing zone, heater, and thermocouple information. The user can utilize selectable pull down list 92 to remove, add, and modify heater information. GUI 88 includes data input field 94 for max zones and save button 96 for saving the max zone number. GUI 88 also includes data input fields 98 for the coordinates, angle, length, and power of the heater selected and drop down box 100 for the heater type. The user can recalculate heater information based on data input into data input fields 98 or drop down box 100 by clicking on recalculate button 102. The user can also input the power of a zone in data input field 103. GUI 88 also includes a number of buttons for modifying the information in selectable pull down list 92, including, but not limited to, add zone button, delete zone button, add heater button, delete heater button, save changes button, re number zones button, refresh from db, and configure heaters button.

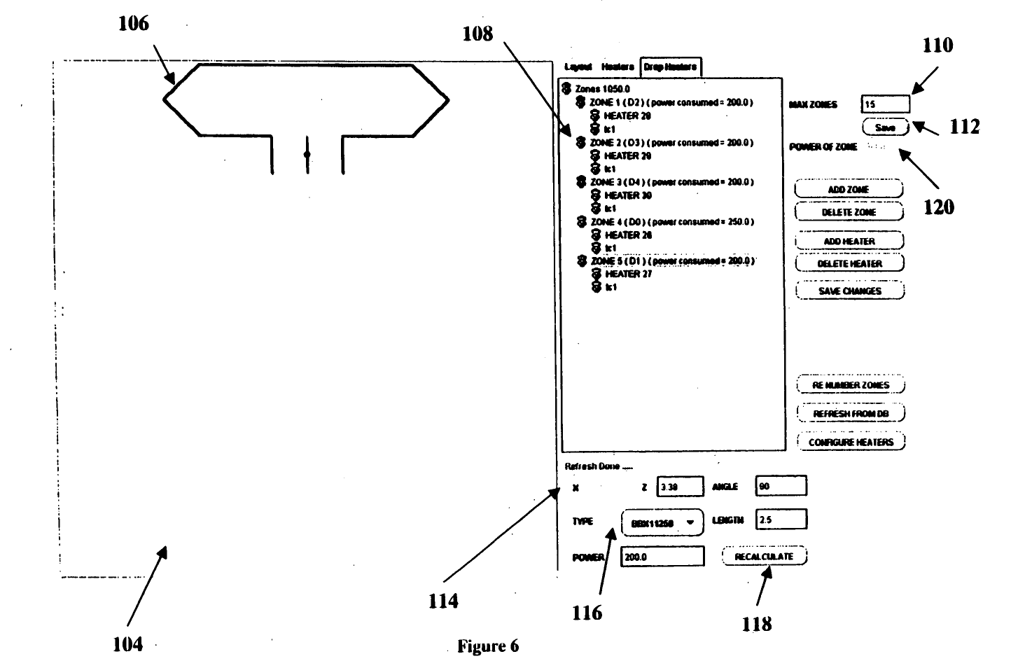

FIG. 6 is a GUI for displaying and modifying drop heaters according to one embodiment of the present invention. GUI 104 includes graphic representation 106 of a manifold with drops and drop heaters. GUI 104 also includes a drop heater tab for displaying and modifying drop heater information. GUI 104 includes selectable pull down list 108 containing zone, drop heater, and thermocouple information. The user can utilize selectable pull down list 108 to remove, add, and modify drop heater information. GUI 104 includes data input field 110 for max zones and save button 112 for saving the max zones number. GUI 104 also includes data input fields 114 for the coordinates, angle, length, and power of the drop heater selected and drop down box 116 for the heater type. The user can recalculate drop heater information based on data input into data input fields 114 or drop down box 116 by clicking on recalculate button 118. The user can also input the power of a zone in data input field 120. GUI 104 also includes a number of buttons for modifying the information in selectable pull down list 108, including, but not limited to, add zone button, delete zone button, add heater button, delete heater button, save changes button, renumber zones button, refresh from db, and configure heaters button.

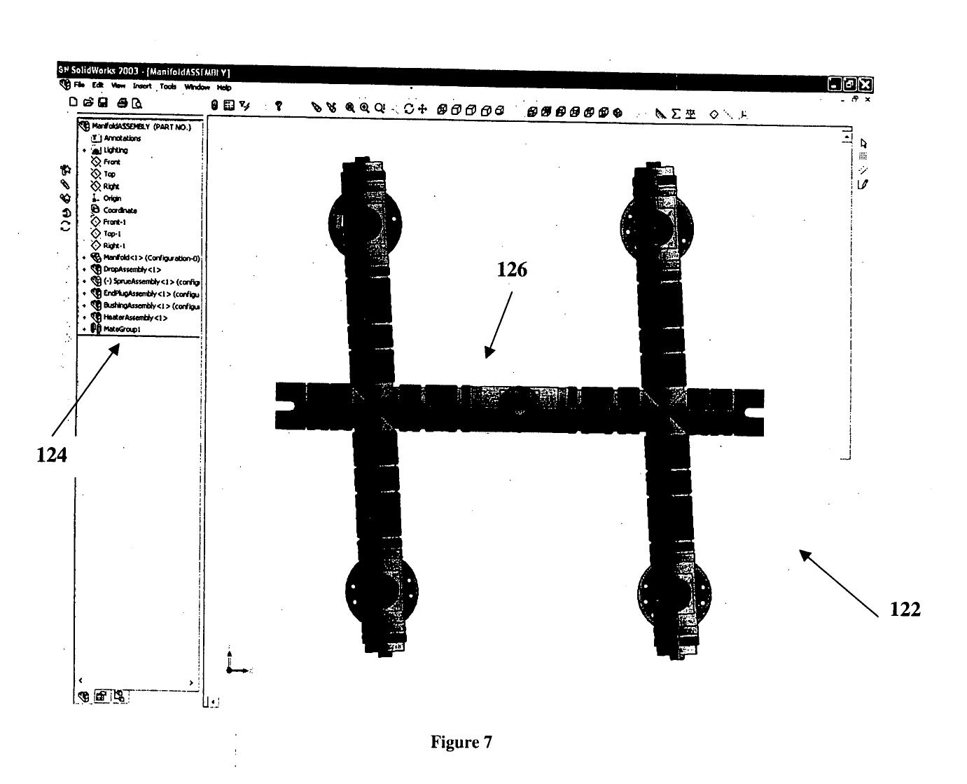

FIG. 7 is a GUI for displaying a three-dimensional rendering of a manifold assembly according to one embodiment of the present invention. The three-dimensional manifold assembly is produced based on the input provided through GUIs 60, 70, 88, and 104. The design module also produced two-dimensional data for use in automatically producing blueprints once the user finalizes the three-dimensional manifold assembly. GUI 122 includes part number list 124 and three-dimensional rendering 126 of a manifold assembly, top view.

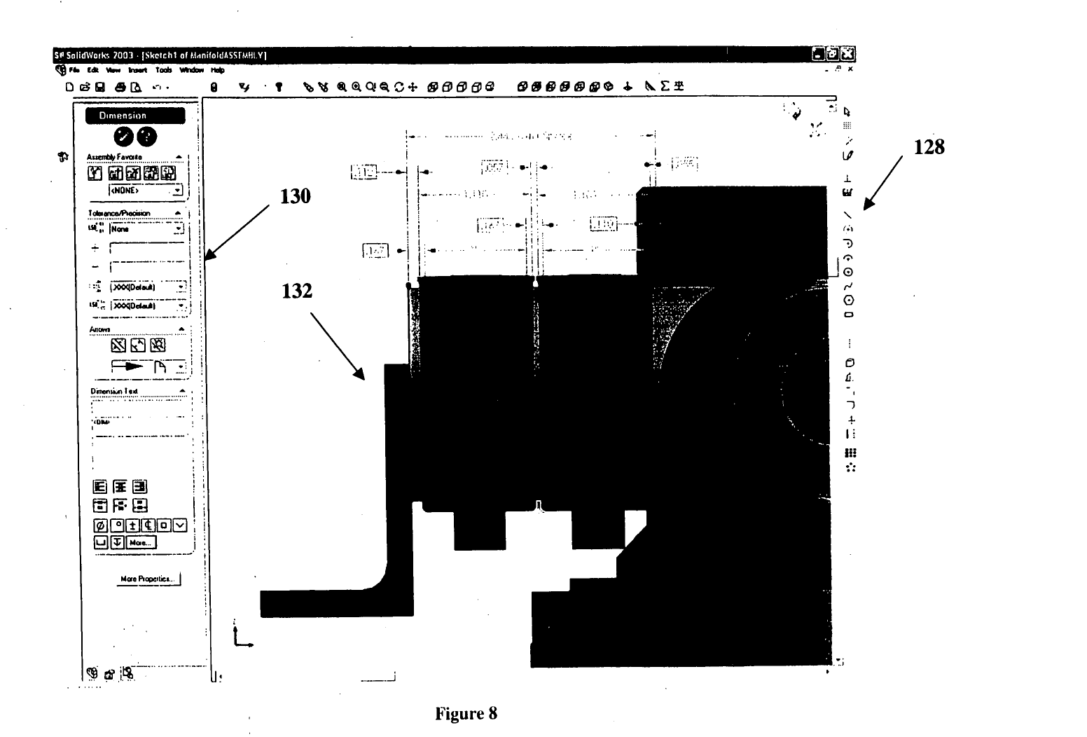

FIG. 8 is a GUI for displaying and modifying a three-dimensional rendering of a manifold assembly according to one embodiment of the present invention. GUI 128 includes toolkits 130 for tolerance/precision, arrows, and dimension text and three-dimensional rendering 132 of a manifold assembly, side view. The user can use toolkits 130 to add dimensions, text, arrows, etc. to three-dimensional rendering 132. Toolkits 130 can also be used to correct gap violations. It should be understood that as the user adds detail to or modifies three-dimensional rendering 132, the design module updates the two-dimensional data behind three-dimensional rendering 132.

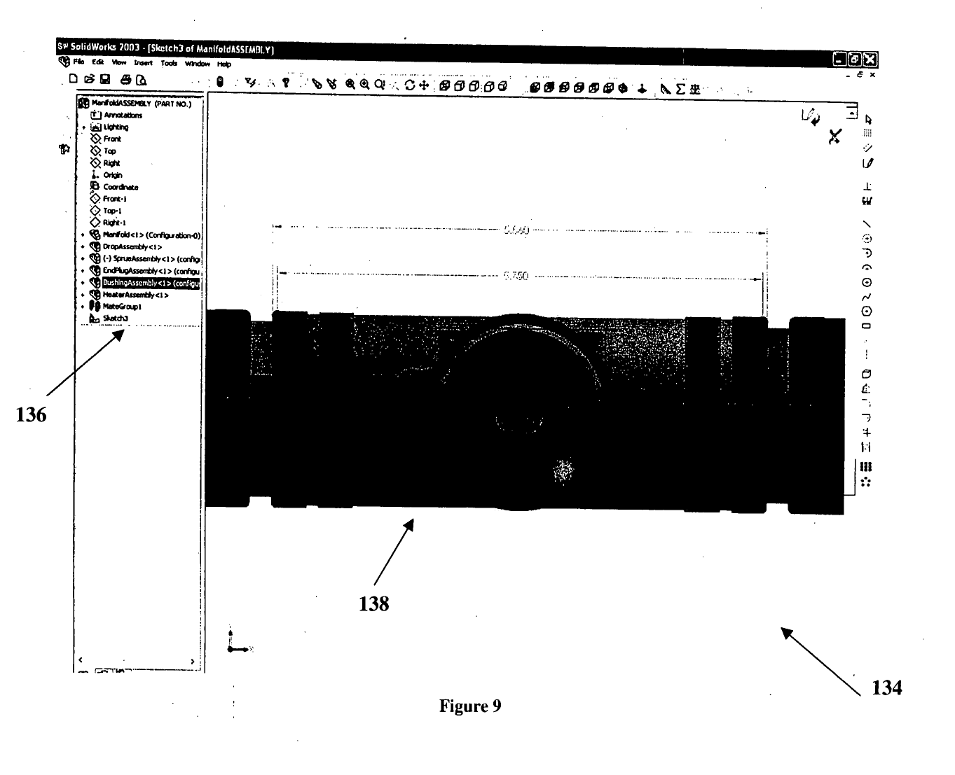

FIG. 9 is a GUI for displaying and modifying a three-dimensional rendering of a manifold assembly according to one embodiment of the present invention. GUI 134 includes part number list 136 and three-dimensional rendering 138 of a manifold assembly, top view. By reviewing rendering 138, the user uncovers that the heater depicted does not exist. Therefore, the user can utilize the design module to down size the heater by two inches. This down size is reflected in the two-dimensional data.

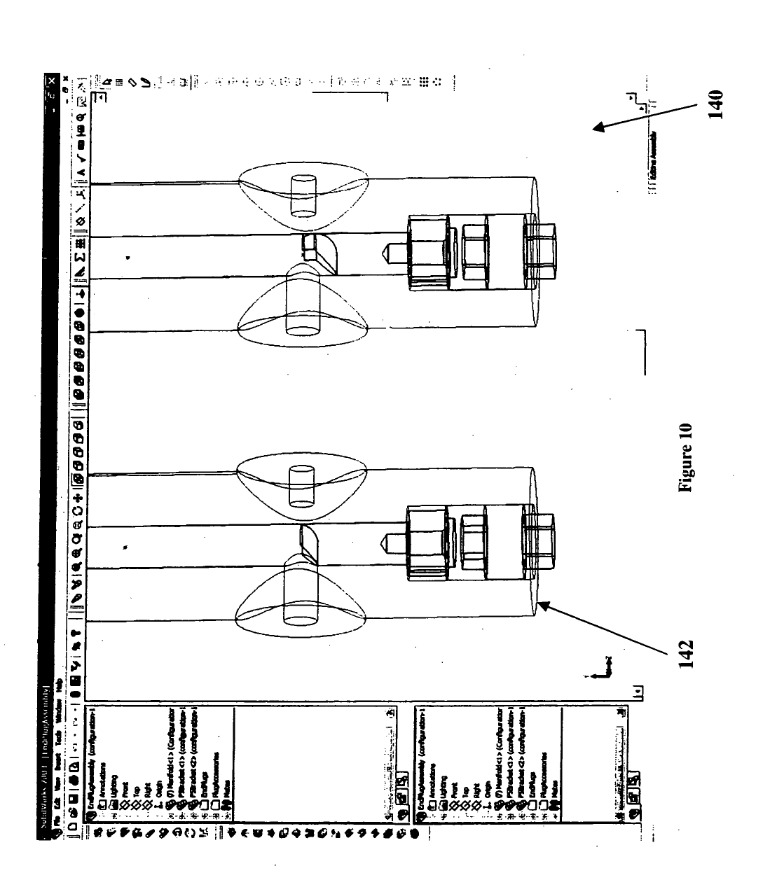

FIG. 10 is a GUI for displaying and modifying a three-dimensional rendering of an end plug cut of a manifold assembly according to one embodiment of the present invention. GUI 140 includes rendering 142 showing an end plug cut that does not mate with the drop diameter in position or radius. By reviewing rendering 142, the user uncovers this flaw. The user can utilize the design module to correct the flaw. The correction is reflected in the two-dimensional data.

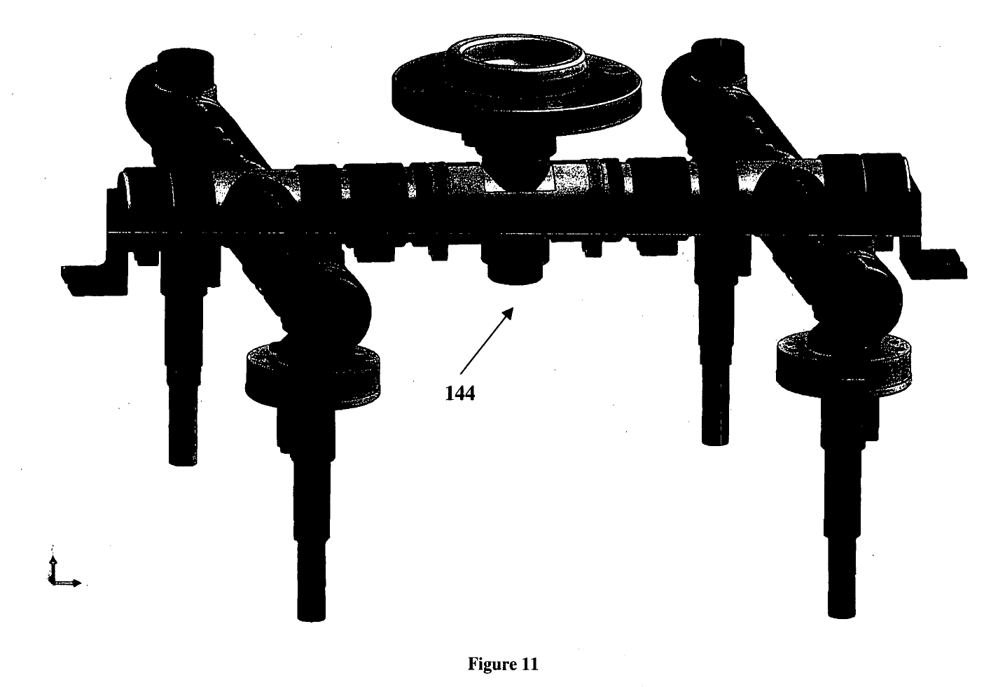

FIG. 11 is a three-dimensional rendering of a completed manifold assembly according to one embodiment of the present invention. Three-dimensional rendering 144 reflects the user's inputs and modifications according to the GUIs of FIG. 3 through 10, as well as other changes not specifically described. Since, three-dimensional rendering 144 has a two-dimensional backbone carried by the design module, two-dimensional blueprints can be produced automatically, without the need for additional design time.

It should be understood that post-processing step(s) can be carried out on the two-dimensional blueprints. For example, post-processing step(s) can include refining dimensions, cutting sections, updating charts (i.e. hot and cold numbers), updating the title block on all drawing sheets, placing balloons on ISO for bill of materials, and/or updating an electrical chart.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A semi-automated computer-implemented method for designing manifold assemblies, the method comprised of:
receiving a number of design parameters for the design of a manifold assembly; and
applying the number of design parameters to a heater and zoning logic to generate a manifold assembly design.

2. The method of claim 1 further comprising generating two-dimensional data for the manifold assembly based on the number of design parameters and the heater and zoning logic.

3. The method of claim 2 further comprising automatically generating a blueprint based on the two-dimensional data for the manifold assembly.

4. The method of claim 1 wherein the manifold assembly design includes a three-dimensional rendering of the manifold assembly.

5. The method of claim 2 further comprising automatically generating a bill of materials based on the two-dimensional data for the manifold assembly.

6. The method of claim 1 wherein the number of design parameters is comprised of manifold size, sprue coordinates, and drop coordinates.

7. The method of claim 1 wherein the heater and zoning logic includes minimizing overall heater gap, minimize number of zones, and minimize number of heaters.

8. The method of claim 1 wherein the manifold assembly design is comprised of a manifold, one or more drops, one or more heaters, one or more thermocouples, and one or more plugs.

9. A semi-automated computer-implemented system for designing manifold assemblies, the system comprised of one or more computers, the one or more computers configured to:
receive a number of design parameters for the design of a manifold assembly; and
apply the number of design parameters to a heater and zoning logic to generate a manifold assembly design.

10. The system of claim 9 wherein the one or more computers is further configured to generate two-dimensional data for the manifold assembly based on the number of design parameters and the heater and zoning logic.

11. The system of claim 10 wherein the one or more computers is further configured to automatically generate a blueprint based on the two-dimensional data for the manifold assembly.

12. The system of claim 9 wherein the manifold assembly design includes a three-dimensional rendering of the manifold assembly.

13. The system of claim 10 wherein the one or more computers is further configured to automatically generate a bill of materials based on the two-dimensional data for the manifold assembly.

14. The system of claim 9 wherein the number of design parameters is comprised of manifold size, sprue coordinates, and drop coordinates.

15. The system of claim 9 wherein the heater and zoning logic includes minimizing overall heater gap, minimize number of zones, and minimize number of heaters.

16. The system of claim 9 wherein the manifold assembly design is comprised of a manifold, one or more drops, one or more heaters, one or more thermocouples, and one or more plugs.

17. A semi-automated computer-implemented apparatus for designing manifold assemblies, the apparatus is comprised of:
means for receiving a number of design parameters for the design of a manifold assembly; and
means for applying the number of design parameters to a heater and zoning logic to generate a manifold assembly design.

18. The apparatus of claim 17 further comprising means for generating two-dimensional data for the manifold assembly based on the number of design parameters and the heater and zoning logic.

19. The apparatus of claim 18 further comprising means for automatically generating a blueprint based on the two-dimensional data for the manifold assembly.

20. The apparatus of claim 18 further comprising means for automatically generating a bill of materials based on the two-dimensional data for the manifold assembly.
